(19) United States
(12) Patent Application Publication
(10) Pub. No.: US 2026/0157908 A1
(43) Pub. Date: Jun. 11, 2026

(54) POSITIONING DEVICE FOR HOLDING AND PROTECTING A PATIENT'S ARM DURING A MEDICAL PROCEDURE

(71) Applicant: BONE FOAM, INC., Corcoran, MN (US)

(72) Inventors: Shea RYAN, Corcoran, MN (US); Benjamin J. WATTERS, III, Saint Louis Park, MN (US); Peter A. COLE, JR., North Oaks, MN (US)

(21) Appl. No.: 19/415,206

(22) Filed: Dec. 10, 2025

Related U.S. Application Data
(60) Provisional application No. 63/730,263, filed on Dec. 10, 2024.

(51) Int. Cl. A61G 13/12

(52) U.S. Cl. CPC A61G 13/1235; A61G 13/129

(57) ABSTRACT

Disclosed are arm positioning devices configured to position and/or protect a patient arm during a medical procedure. The device is moveable between an unwrapped configuration for receiving the patient arm and a wrapped configuration for securing the patient arm. The device comprises a middle portion, a first wrap extending from a first side of the middle portion, and a second wrap extending from a second side of the middle portion, the first and second wraps configured to enclose the patient arm. The device is configured to bend according to the flexion and extension motion of a joint of the patient's supported arm. The device comprises a cutout that aligns with the joint when the device is secured to the patient arm in the wrapped configuration.

### CROSS-REFERENCE TO RELATED APPLICATION

This application claims the benefit of U.S. Provisional Application No. 63/730,263, filed Dec. 10, 2024, which is incorporated by reference in its entirety.

### BACKGROUND

As surgeries shift to ambulatory surgical centers (ASCs), operating rooms are shrinking while the size of equipment, including robotics and traction tables, expands. In this evolving landscape, operating room space is becoming scarce and valuable. Optimizing patient positioning is crucial, often necessitating strategic placement of nonoperative anatomy away from the surgical field to provide good operating conditions and effective access to the operative site. During surgery, patients may be placed in positions that are not completely physiologically stable or comfortable and need to be stabilized and maintained in these positions for considerable amounts of time. Improper positioning of the patient can lead to injury and potential disability and functional loss.

Several surgical procedures place the patient in the supine, fowler, or semi-fowler (beach chair) positions. During some of these procedures, one or both arms may need to be positioned and protected so as not to fall within the operative field. The arm or arms are often taped and padded with an assortment of pillows, towels, and/or other simple materials. This preparation takes up valuable time in the Operating Room and is not always successful. The inconsistency and variability of the ad-hoc setup can put the patient at risk for soft tissue injuries and/or neuropathy.

Accordingly, there is an ongoing need for effective patient limb positioning devices. In particular, there is an ongoing need for arm positioning devices capable of effectively holding and protecting a patient's arm during surgery in a consistent and safe manner and that also allows for easy and relatively rapid setup in the operating room.

### SUMMARY

Disclosed are embodiments of an arm positioning device configured to hold and/or protect an arm of a patient during a medical procedure. The arm positioning device may comprise an elongate body having a longitudinal axis and configured to surround at least a portion of the patient's arm. The device body may be configured in a wrapped configuration and in an unwrapped configuration. When in the unwrapped configuration, the device body may be configured to receive the arm of the patient, and when in the wrapped configuration the device body may define a lumen configured to at least partially enclose the arm of the patient. The lumen may be defined by forming the inner surface of the elongate body of the positioning device into a generally cylindrical shape but that can be bent when bending the arm into a desired position.

The body of the arm positioning device may comprise a compressible material that is configured to cushion forces acting on the patient's arm and which advantageously facilitates distribution of the weight of the arm on the patient's body and/or support surface. In some embodiments, the device body comprises a polymer foam material.

The body of the arm positioning device may comprise a middle portion, a first wrap portion extending from a first side of the middle portion, and second wrap portion extending from a second side of the middle portion. The first and second wrap portions may be relatively thin and flexible to enable the first and second wrap portions to enclose around the patient's arm and hold and protect the arm within the positioning device. The first and second wrap portions may be integrally formed together or comprise a connection mechanism for connecting the first and second wrap portions together.

In some embodiments, the middle portion of the arm positioning device can have a thickness greater than that of the first and second wrap portions. The body may taper in thickness from the middle portion to the first and second wrap portions to provide flexibility to the wrap portions for enclosing the patient's arm while enabling the middle portion to effectively cushion the patient arm. The thickness of the middle portion may be configured to fill a gap between the upper arm and torso of a patient when the arm is oriented across the patient's torso and held by the device. This may enable the positioning device to elevate the arm at a comfortable height for the patient and assist the medical practitioner in positioning the arm while in the positioning device.

The middle portion, first wrap portion, and second wrap portion of the arm positioning device may comprise multiple portions, including a proximal portion and a distal portion. The proximal portion may be configured in length to approximate the length of an upper portion of the patient's arm held therein and the distal portion may be configured in length to approximate the length of a lower portion of the patient's arm. The positioning device may be configured to facilitate bending of the distal portion of the device relative to the proximal portion of the arm positioning device, with the bending direction being transverse to the longitudinal axis of the positioning device.

One or more cutouts may be formed in the device body to facilitate bending of the arm support device and the arm positioned therein. The body may define a first cutout configured to facilitate bending the distal portion of the device body in the bending direction of the patient's arm. The first cutout may comprise an essentially V-shaped cutout. The first cutout may extend into the middle portion of the device body such that the device is configured for orienting the middle portion of the positioning device towards the inside of the elbow joint. The first cutout may be configured to align with the joint along the patient's arm when the positioning device is in the wrapped configuration. The arm positioning device may also comprise a second cutout formed in the end of the first wrap portion, with the second cutout advantageously being aligned with the first cutout.

The arm positioning device may also comprise a securement mechanism configured to restrain or hold the positioning device to the patient's body and/or a support structure, such as an operating table, arm board, or other structure. The securement mechanism may comprise an anchoring strap, which may be received by a slot formed in the middle portion and extend along the axial direction of the body. The anchoring strap may attach to the body of the arm positioning device and to the patient's body and/or support structure so as to secure the device body to the patient's body and/or support structure. The arm positioning device, including the anchoring strap, may be arranged to prevent horizontal abduction of the shoulder of the patient's arm being held during use.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 illustrates a right perspective view of an exemplary arm positioning device of the disclosure;

FIG. 2 illustrates a left perspective view of the exemplary arm positioning device of FIG. 1;

FIG. 3 illustrates a front view of the exemplary arm positioning device of FIG. 1;

FIG. 4 illustrates a front view of another exemplary arm positioning device, wherein the first and second wrap portions are integrally connected, the device body forming a unitary tubular structure;

FIG. 5 illustrates a right side view of the exemplary arm positioning device of FIG. 1;

FIG. 6 illustrates a side perspective view of an exemplary arm positioning device in an unwrapped configuration and a patient's arm extending along an interior surface of the arm positioning device;

FIG. 7 illustrates a front perspective view of the exemplary arm positioning device in the unwrapped configuration and a patient's arm extending along the inner surface of the arm support device;

FIG. 8 illustrates the exemplary arm positioning device of FIG. 1 in the wrapped configuration disposed about the arm of a patient.

FIG. 9 illustrates the exemplary arm positioning device of FIG. 1 being used to position and protect an arm while the patient in a supine position.

FIG. 10 illustrate the exemplary arm positioning device of FIG. 1.

FIG. 11 illustrates an arm positioning device assembly comprising the arm support device of FIG. 1 and an anchoring strap connected to the arm positioning device.

FIG. 12 illustrates the arm positioning device assembly of FIG. 10 worn by a patient, with the position of the patient's arm being secured by the anchoring strap.

### DETAILED DESCRIPTION

### Introduction

Described herein are arm positioning devices and methods for holding, positioning, and/or protecting a patient's arm in a medical environment, such as during a surgical procedure, post-surgical recovery, or other medical procedure. Arm positioning systems have conventionally employed off-the-shelf materials, including towels, pillows and bed sheets secured with belts or straps in an ad-hoc manner to the arm of the patient. The process of positioning a patient's arm is often cumbersome and requires excessive amounts of time from the medical practitioner. Conventional positioning systems may also be bulky, taking up valuable space in the medical environment and obstructing the medical practitioner during a medical procedure

The arm positioning device described herein addresses these challenges by enabling quick and effective positioning and protection of a patient's arm. The unitary structure of the device body enables easy handling and attachment of the device to the patient's arm. Using flexible wrap portions, the arm positioning device may be quickly wrapped around and secured to the patient's arm. The wrap portions may be selectively adjustable according to the size and needs of the patient. The arm positioning device may also comprise a compressible material (e.g., a polymer foam material) to cushion the patient's arm, reducing and/or eliminating the formation of sores and/or bruises to the arm during use. The arm positioning device may comprise an anchoring strap that securely attaches the device to a patient's body or support surface and which can prevent the arm from moving during the medical procedure and possibly entering the surgical site.

### Definitions

The term “limb” refers to a limb of a patient. While within this disclosure, the term “limb” generally refers to an arm of the patient, the “limb” may in alternative implementations be a leg, a foot, or other limb of the patient, or may refer to a digit (i.e., a finger or toe) of the patient. The arm positioning devices can be adapted for use with other limbs if desired.

The terms “proximal” and “distal” refer to directions related to the patient's body and/or to portions of the positioning device lying in directions associated with the patient's body. As common in the art, the term “proximal” may refer to a portion of the patient's body lying towards the center of the body, may refer to a direction towards the center of the patient's body, or may refer to a portion of the device lying closer to the center of the patient's body. Conversely, the term “distal” may refer to a portion of the patient's body lying away from the center of the body, may refer to a direction away from the center of the patient's body, or may refer to a portion of the device lying further away from the center of the patient's body.

The terms “flexion” and “extension” refer to movements of the patient's elbow joint and a corresponding motion in the arm positioning device. “Extension” refers to straightening of the elbow joint, wherein the angle between the upper arm and the lower arm (i.e., forearm) increase, whereas “flexion” refers to an opposite motion wherein the angle between the upper arm and the forearm decreases. “Extension” similarly refers to straightening of the body of the arm positioning device, wherein the angle between the proximal portion and the distal portion of the arm positioning device increases, whereas “flexion” refers to an opposite motion wherein the angle between the proximal portion and the distal portion decreases.

The term “radially” refers to a direction along a circumference of the arm positioning device, such as a direction extending along the outer surface of the arm positioning device or the inner surface of the lumen in a direction perpendicular to a longitudinal axis of the device.

The terms “medially” and “laterally” refer to directions relative to the patient's body. As common in the art, “medial” refers to a direction towards the center of a component of the patient's body (e.g., towards the center of a patient's arm) and “lateral” refers to directions opposite of “medial” or away from the center of a component of the patient's body (e.g., a portion of the torso away from the center line and/or heart of the patient).

The term “medical procedure” may refer to a series of steps taken to diagnose, treat, or monitor a patient's condition or illness. The “medical procedure” includes surgery or steps taken in preparation for surgery, and it includes post-surgical procedures, including recovery.

The term “support surface” may refer to a surface to which a portion of the positioning device is secured to maintain the position of the patient's arm, such as an operating table, gurney, chair, or the like. The term “support surface” may refer to a surface that supports the arm of the patient and may refer to the same surface as the support surface that support's other portions of the patient's body.

### Overview of Device Structure

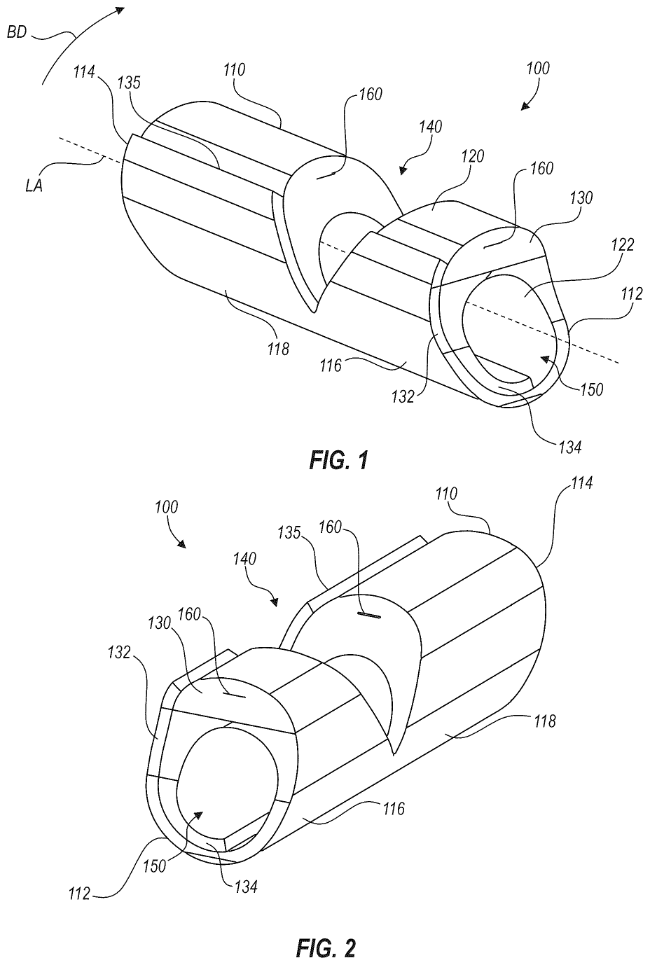

FIGS. 1 through 5 illustrate an arm positioning device 100 for protecting and/or positioning an arm of a patient during a medical procedure. FIGS. 1 and 2 illustrate perspective views of the arm positioning device 100. The positioning device 100 comprises an elongate body 110 that, when in a wrapped configuration, forms a lumen 150 configured to receive and at least partially enclose the patient's arm. The body 110 extends along a longitudinal axis LA from a proximal end 112 to a distal end 114. The body 110 comprises a proximal portion 116 and a distal portion 118 configured to contact proximal and distal portions of the patient's arm, respectively. The device body 110 may be configured to bend or rotate the distal portion 118 relative to the proximal portion 116 (e.g., in a bending direction BD) to accommodate the flexing and extending motions of a joint of the patient's arm.

The arm positioning device 100 is configured to protect the arm of the patient during positioning of the arm by medical practitioners and from contact and awkward movements during a medical procedure. The device body 110 may comprise a compressible material configured to cushion the arm of the patient. The body 110 may comprise a polymer foam material, such as an open or closed cell foam, a “memory foam” (e.g., low-resilience polyurethane foam and/or other viscoelastic foams), rubber materials, gel padding, or combinations thereof. Some embodiments may also include a water-resistant coating, such as a flexible, water-resistant polymer (e.g., vinyl-based) that coats the foam material and allows for easy cleaning of the device. In some embodiments, the outer surface 120 of the body 110 may comprise or form a shell comprising a relatively rigid or semi-rigid material, such as a rigid or semi-rigid plastic, to protect the patient's arm from impact. In some embodiments, the device 100 may be configured for single use, such that the device 100 is discarded after use by the patient.

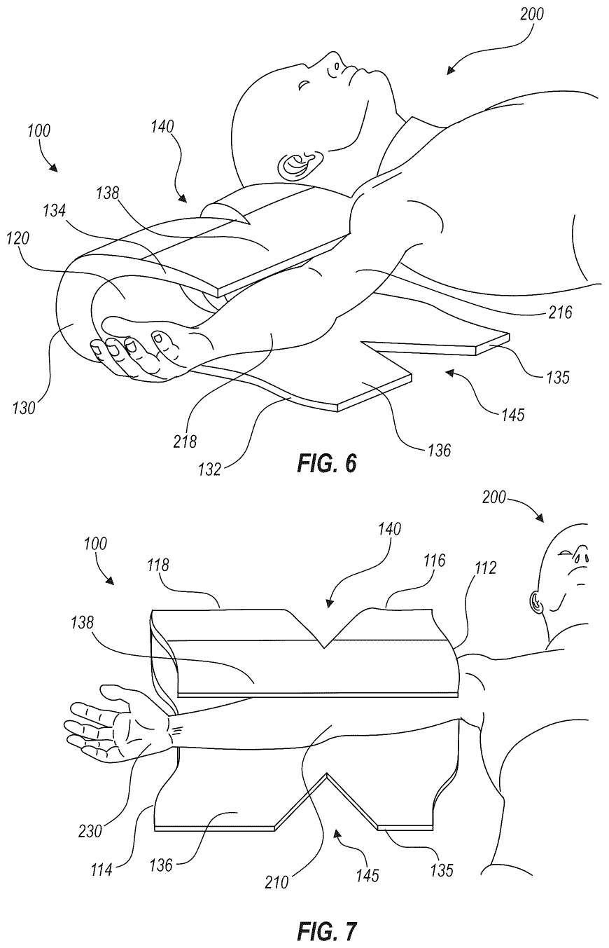

The arm positioning device 100 may be configurable between a wrapped configuration and an unwrapped configuration, with FIGS. 1 through 3 illustrating the device 100 in a wrapped configuration, and FIGS. 6 through 7 illustrating the device 100 in an unwrapped configuration. The arm positioning device 100 may be configured to secure to the arm of the patient in the wrapped configuration and may be configured to receive and/or release the arm of the patient when in the unwrapped configuration.

The arm positioning device 100 may be configured to form a generally tubular body 110 when in the wrapped configuration such that the outer surface 120 may approximate the surface of a cylinder or other generally round cross-sectional shape. This may beneficially deflect and/or distribute exterior forces acting on the device 100 so as to reduce forces on the patient's arm during use. However, the outer surface 120 of the device 100 may be configured to form other shapes. That is, the circumference of the outer surface may approximate a square, rectangular, or polygonal shape, or may approximate an irregular shape, or may approximate a generally circular or elliptical shape, as illustrated.

When in the wrapped configuration, the device body 110 may form the inner surface 122 into a generally cylindrical shape, forming a lumen 150, such that the lumen 150 comprises a generally circular or elliptical cross-section configured to center the arm of the patient within the lumen 150. However, in other embodiments, the body 110 may be configured to form a lumen 150 having a square, rectangular, triangular, or a polygonal cross-section, or having an irregular cross-section, such as an anatomical cross-section that approximates the anatomy of an arm, including the upper arm and forearm, with the cross-section of the proximal portion 118 generally corresponding to the anatomy of the upper arm and the cross-section of the proximal portion 118 generally corresponding to the anatomy of the forearm.

The body 110 may comprise a middle portion 130, a first wrap portion 132, and a second wrap portion 134 that extend along the longitudinal axis LA of the device 100 when in a straight configuration. The middle portion 130 may form a pre-defined curve configured to support the arm of the patient and may be less flexible compared to the first and second wrap portions 132, 134 (e.g., due to different materials and/or thicknesses). The first and second wrap portions 132, 134 may comprise flexible flaps, strips, skirts, or other coverings extending from the middle portion 130. The first wrap portion 132 extends in a first direction from the middle portion 130 while the second wrap portion 134 extends in a second direction opposite the first direction from the middle portion 130. The first and second wrap portions 132, 134 may be relatively flexible to enable the wrap portions 132, 134 to extend from the middle portion 130 and overlap to form the lumen 150. In this manner, the wrap portions 132, 134 may at least partially enclose the arm and secure the arm (e.g., elbow) with the middle portion 130 of the device 100.

The first wrap portion 132 may extend from the middle portion 130 to a greater length than the second wrap portions 134. Specifically, the first wrap portion 132 may extend to two, three, or more than three times the length of the second wrap portion 134 to enable the first wrap portion 132 to surround and cover the second wrap portion 134. The relatively decreased length of the second wrap portion 134 may also assist in securing the arm positioning device 100 to the patient's arm, as will be further described below.

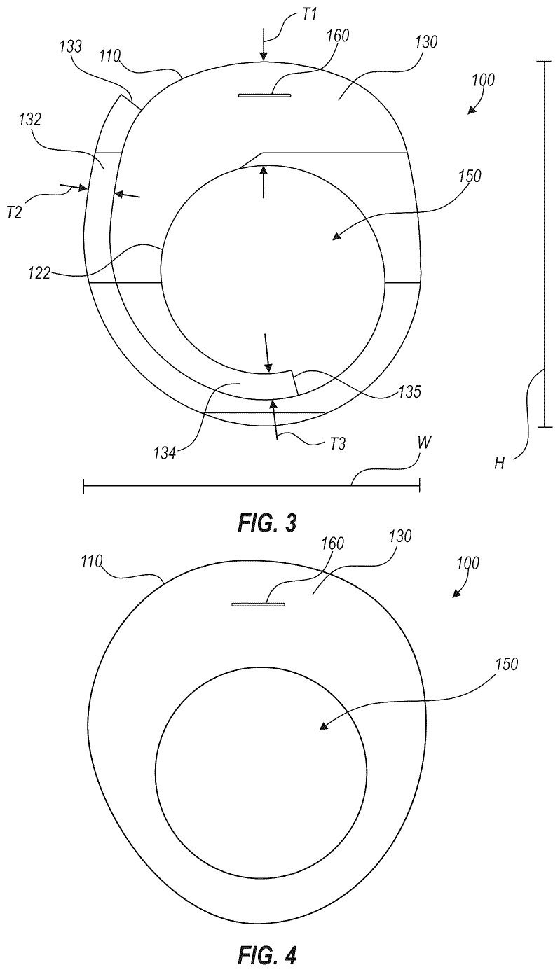

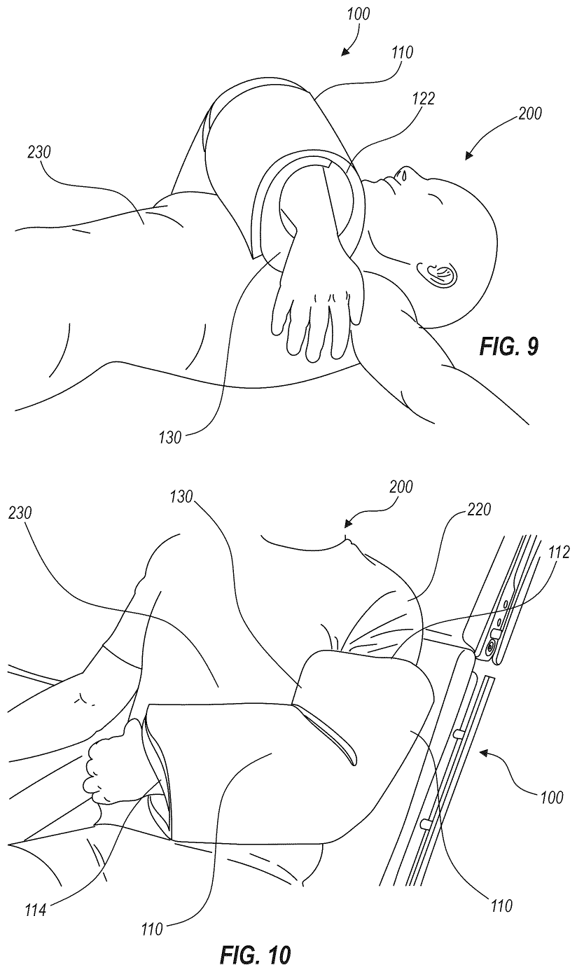

FIG. 3 illustrates a front view of the arm positioning device 100 and particularly shows the relative thicknesses of the middle portion 130 and the first and second wrap portions 132, 134. The middle portion 130 may have a first thickness T1 greater than a second thickness T2 and a third thickness T3 at or near the ends 133, 135 of the first and second wrap portions 132, 134, respectively. This middle portion 130 may be configured to be oriented between the patient's arm and torso during use, or between the patient's arm and a support surface. The first thickness T1 of the middle portion 130 may be configured to provide support to the patient's arm when the middle portion 130 is oriented between the arm and the torso of the patient, the middle portion 130 providing a gap between the arm and the torso of the patient. That is, the middle portion 130 may rest upon the patient's torso beneath the patient's arm and may have a first thickness T1 sufficient to lift the arm of the patient to a comfortable height above the torso (see FIG. 9). For example, the first thickness T1 of the middle portion 130 may be sufficient to enable the elbow joint of a patient's arm to flex up to an approximately 90 degree angle when positioned over the chest without exertion by the patient, such that the forearm can rest on the chest of the patient.

The first thickness T1 of the middle portion 130 may be within a range from approximately 0.75 inches to approximately 4 inches, or from approximately 1 inch to approximately 3 inches, or from approximately 1.5 inches to approximately 2 inches, or from approximately 1.6 inches to approximately 1.8 inches, or may extend within a range having any two of the foregoing values as endpoints. The foregoing ranges of the first thickness T1 have been found effective to comfortably elevate the arm above the torso of the patient.

The body 110 of the arm positioning device 100 may taper from the center of the middle portion 130 radially along the first and second wraps 132, 134 to a thickness T2 of the first wrap portion 132 and a thickness T3 of the second wrap portion 134. The thicknesses T2, T3 may be the same or may be different. The thicknesses T2, T3 of the first and second wrap portions 132, 134 may be within a range from approximately 0.25 inch to approximately 1.25 inches, or from approximately 0.3 inch to approximately 1 inch, or from approximately 0.4 inch to approximately 0.65 inch, or from approximately 0.5 inch to approximately 0.55 inch, or may be within a range having any two of the foregoing values as endpoints. The foregoing thicknesses have been found effective to provide the required flexibility of the wrap portions 132, 134 and to enable medical practitioners to easily maneuver the wrap portions 132, 134. In some embodiments, the ends 133, 135 of the first and/or second wrap portions 132, 134 may taper to a point to provide a relatively smooth inner surface 122 of the lumen 150 and/or outer surface 120 of the body 110.

The height H and width W of the arm positioning device 100 when in the wrapped configuration may vary depending on the size of the arm of the patient. In some embodiments, the middle portion 130 may have a first thickness T1 that is greater than the sum of the second and third thicknesses T2, T3 of the wraps 132, 134. In at least some embodiments, the arm positioning device 100 may have a height H that is greater than the width W. For example, an arm positioning device 100 may have a height H of approximately 7 inches and may have a width W of approximately 6.5 inches.

FIG. 4 illustrates a front view of an alternative body 110 of an arm positioning device 100. Specifically, the body 110 may comprise a tubular structure having a relatively thick middle portion 130 but wherein the first and second wrap portions 132, 134 are integrally connected to form a continuous ring extending along the longitudinal axis. Such a device would have only one configuration rather than the wrapped and unwrapped configurations described above. The arm positioning device 100 may be secured to the arm of the patient by inserting the arm through the lumen 150 of the device 100. Although an arm positioning device 100 having distinct and separate first and second wrap portions 132, 134 (as described above in relation to FIGS. 1-3) may be preferable to enable a quick and adjustable securement of the device 100 to the arm of the patient, the present disclosure contemplates such embodiments as those illustrated in FIG. 4 that may be employed to achieve many of the same benefits.

### Cutout Configurations

Returning to FIGS. 1 and 2, the device body 110 may define a first cutout 140 to facilitate bending or rotating of the distal portion 118 relative to the proximal portion 116 of the arm positioning device 100. The first cutout 140 may extend from the outer surface 120 of the body 110 into the middle portion 130 and may extend therefrom into the first and second wrap portions 132, 134. Forming the first cutout 140 in the middle portion 130 ensures that the joint of the arm (e.g., the elbow of the patient) may be flexed when the device 100 is positioned over the torso while maintaining the position of the middle portion 130 between the arm and the torso of the patient.

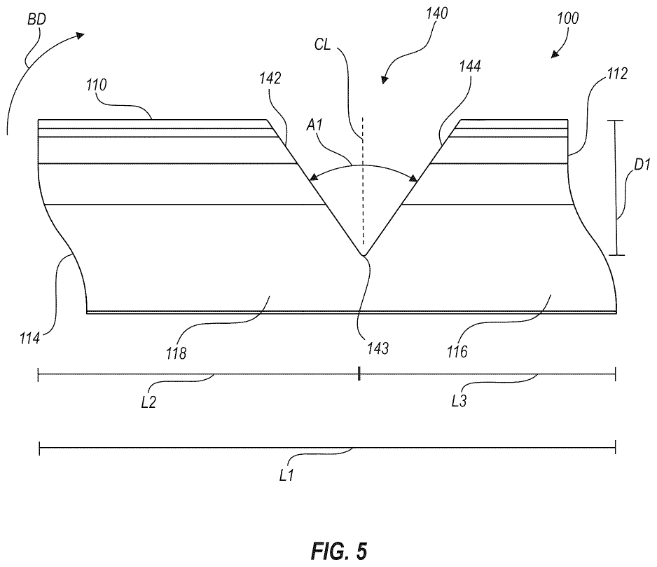

FIG. 5 illustrates a side view of the arm positioning device 100 to illustrate the profile of the first cutout 140. The profile of the first cutout 140 may be formed into one of several shapes, including a rectangular shape, a U-shape, or (as illustrated) a V-shape. A V-shaped cutout profile may be preferable in that it may be easier to manufacture. For example, the first cutout 140 may be manufactured by simply forming two straight cuts in the body 110, each cut extending transverse to the longitudinal axis LA. The first cutout 140 may be formed by cutting through a portion of the body 110 when the device 100 is in either a wrapped or an unwrapped configuration. Alternatively, the first cutout 140 may be formed through an extrusion process.

The body 110 may form first and second walls 142, 144 of the first cutout 140, which may be oriented at a cutout angle A1. The cutout angle A1 may be configured to enable a wide range of rotation between the proximal and distal portions 116, 118 of the body 110 to enable a wide and/or full range of motion of a joint (e.g., elbow) of the arm. The first and second walls 142, 144 of the first cutout 140 may be separated by a cutout angle A1 within a range from approximately 30 degrees to approximately 120 degrees, or from approximately 45 degrees to approximately 90 degrees, or from approximately 55 degrees to approximately 80, or may be separated by approximately 70 degrees, or may be separated by a cutout angle within a range having any two of the foregoing as endpoints. These ranges of cutout angles A1 beneficially enable the joint of the arm to be oriented at a broad range of angles according to the desires of the medical practitioners and the needs of the medical procedure.

The first cutout 140 may extend from the outer surface 122 to a depth D1 when the device 100 is in the wrapped configuration. The depth D1 may be greater than half the height of the device 100 when in the wrapped configuration to provide a wide range of flexibility of the device 100. For example, the depth D1 of the first cutout 140, when the device 100 is in the wrapped configuration, may extend within a range from approximately 3.5 inches to approximately 6 inches, or from approximately 4 inches to approximately 5.5 inches, or from approximately 4.5 inches to approximately 5 inches, or may extend within a range having any two of the foregoing as endpoints. Such depths have been found to leave sufficient device structure while also allowing sufficient clearance for effective bending at the cutout 140.

A center line CL of the first cutout 140, extending midway between the first and second walls 142, 144, may extend perpendicular to the longitudinal axis LA of the body 110, such that the first and second walls 142, 144 of the cutout have approximately the same length. In other embodiments, the center line CL may be oriented at a transverse angle to the longitudinal axis LA. That is, the first wall 142 may be oriented at a first angle relative to the longitudinal axis LA and the second wall 144 may be oriented at a second angle different from the first angle relative to the longitudinal axis LA. The angle of the center line CL with the longitudinal axis LA may be chosen so as to better accommodate the flexion and extension motion of the patient's arm.

A corresponding second cutout 145 (see FIG. 6) may be formed in an end of the first wrap portion 132. The second cutout 145 may be aligned with the first cutout portion 140, such that when the first wrap portion 132 overlaps the second wrap portion 134 in the wrapped configuration the second cutout 145 overlaps with the first cutout 140. The second cutout 145 may align with the first cutout 140 to facilitate bending or rotation at the same location of the body 110. The position of the first cutout 140 may define the proximal and distal portions 116, 118 of the body 110. For example, the center line CL of the first cutout 140 and/or the deepest point 143 of the first cutout 140 (i.e., the point of the first cutout 140 extending furthest from the middle portion 130) may separate the proximal portion 116 from the distal portion 118.

The length of the proximal and distal portions 116, 118 of the arm positioning device 100 may be configured according to the size of the arm of the patient. For example, a relatively small arm positioning device 100 having smaller dimensions may be configured to accommodate young patients or patients of smaller size (i.e., patients having thinner and/or shorter arms), while a relatively large arm positioning device 100 having larger dimensions may be configured to accommodate adults or patients of greater size (i.e., patients having thicker and/or longer arms). The proximal portion 116 may be configured in length to accommodate the length of the upper portion of the patient's arm (e.g., upper arm) while the distal portion 118 may be configured in length to accommodate the length of the lower portion of the patient's arm (i.e., the forearm).

As shown in FIG. 5, a length L2 of the distal portion 118 may be greater than a length L3 of the proximal portion 116 of the arm positioning device 100. This arrangement of the arm positioning device 100 may be provided to protect the distal joints of the arm 210, such as the elbow and the wrist, while provide sufficient space to permit greater freedom and/or access to more proximal joints, such as the shoulder 220. The length L1 of the device body 110 may be configured according to the length of the arm of the patient, and/or may be configured in length according to the varying length of many patient's arms. The overall length of the body 110 may extend within a range from approximately 15 inches to approximately 30 inches, or from approximately 18 inches to approximately 24 inches, or from approximately 19 inches to approximately 22 inches, or from approximately 20 inches to approximately 21, or may extend within a range having any two of the foregoing as endpoints. The length of the distal portion 118 may be greater than the length of the proximal portion 116 at least about 20%, 30%, 40%, or 50% and/or less than about 100%, 90%, 70%, or 60%, or a within a range defined by two of the foregoing values. Arm positioning devices 100 having a body 110 with a length within the above ranges have been found to beneficially accommodate the various lengths of patient's arms.

The proximal end 112 may have or form a curved surface, such that the first and/or second wrap portions 132, 134 may extend farther proximally compared to the middle portion 130 of the proximal portion 116. When the arm positioning device 100 is positioned so as to orient the middle portion 130 medially towards the torso of the patient, the curved end of the proximal end 112 enables the shoulder 220 of the patient 200 to rotate towards the torso 230 to a greater degree while maintaining more protection to the upper arm 216 by extending to a greater degree over the lateral and/or posterior portions of the arm 210. See, for example, FIGS. 10 and 12 as used on a patient.

### Wrapped and Unwrapped Configurations

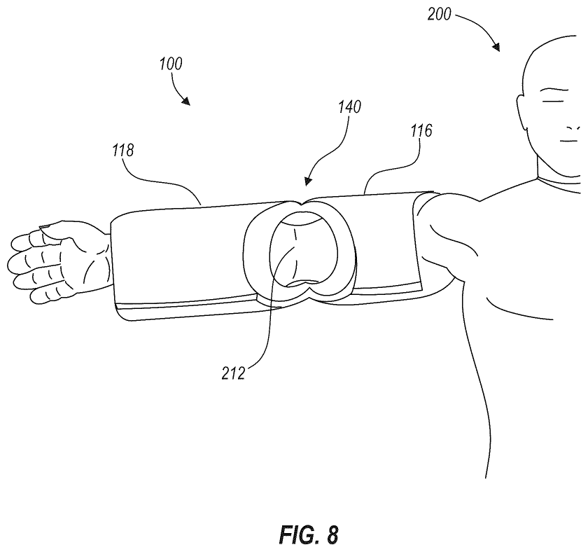

FIGS. 6 through 8 illustrate how the arm positioning device 100 can be attached to an arm 210 (i.e., the arm) of a patient 200. FIGS. 6 and 7 illustrate the device 100 in an unwrapped configuration. When in the unwrapped configuration, the arm positioning device 100 can be positioned on a support surface (e.g., operating table, chair, or arm board), with the first wrap portion 132 contacting and lying on the support surface. FIGS. 6 and 7 also illustrate that the middle portion 130 can be sufficiently stiff in order to maintain the second wrap portion 134 in an elevated position relative to the first wrap portion 132. The shorter length of the second wrap portion 134 can beneficially enable the middle portion 130 to support the entire length of the second wrap portion 134 in the elevated position. The elevated position of the second wrap portion 134 enables and facilitates the medical practitioner setting the patient's arm 210 within the interior of the device 100 without lifting the second wrap portion 134 prior to forming the lumen 150 of the arm positioning device 100 by wrapping the first wrap portion 132 around the second wrap portion 134 (see FIGS. 8 and 9). This advantageously enables a medical practitioner to position the patient's arm 210 within the interior of the device 100 without the aid of another person (e.g., in the case of an unconscious patient 200).

The arm position device 100 may include a connection mechanism to enable the first and second wrap portions 132, 134 to attach to one another. The inner surface 136 of the first wrap portion 132 may comprise a fastener and the outer surface 138 of the second wrap portion 134 may comprise a fastener, with the fastener of the first wrap portion 132 configured to engage with and connect to the fastener of the second wrap portion 134 to form a connection mechanism and attach the first and second wraps 132, 134 together. The connection mechanism may be configured to enable adjustability of the size of the lumen 150 and the overlap between the first and second wrap portions 132, 134.

The connection mechanism may comprise a hook and loop fastening system (e.g., Velcro®) to enable quick attachment of the device 100 to the patient's arm 210 and easy adjustment of the arm positioning device 100 around the patient's arm 210. For example, one or more first hook strips (or loop strips) of a hook and loop fastening system may be attached to the inner surface 136 of the first wrap portion 132 (e.g., with an adhesive) near the end 133 of the first wrap portion 132. One or more complementary second loop strips (or hook strips) of the hook and loop fastening system may be attached to the outer surface 138 of the second wrap portion 134, the one or more loop strips configured to interlock with the one or more hook strips. The one or more second loop strips may be oriented transverse to the end 135 of the second wrap portion 134 or to the longitudinal axis LA and may extend from the end 135 of the second wrap portion 134 towards the middle portion 130. For example, the one or more loop strips may extend perpendicular to the longitudinal axis LA from the end 135 of the second wrap portion 134 towards the middle portion 130. In this manner, a hook strip of the one or more first hook strips may be attached at a desired position along the first wrap portion 132 to adjust the connection between the first and second wrap portions 132, 134 according to the needs of the medical practitioner, the patient, and/or the medical procedure.

FIG. 8 illustrates the arm positioning device 100 secured to the arm 210 of the patient 200. As shown, the arm positioning device 100 may be configured to attach to the arm 210 in a manner so as to generally align the first cutout 140 with the joint 212 of the arm 210, with the proximal portion 116 aligned with and/or covering the upper arm 216 and the distal portion 118 aligned with and/or covering the forearm 218.

### Patient Arm Positioning

FIGS. 9 and 10 illustrate how the arm positioning device 100 can be used in positioning the arm 210 of the patient 200 while the patient 200 is in one of different possible positions. FIG. 9 illustrates that the arm positioning device 100 can be used to position and protect the patient's arm 210 when the patient 200 is in the supine position. For example, when the patient 200 is in the supine position, the patient's arm 210 may be positioned across the torso 230 of the patient 200, such as across the patient's chest. As mentioned above, in such instances the middle portion 130 of the device body 110 may be positioned between the arm 210 and the torso 230 of the patient. This provides padding that cushions the weight of the patient's arm 210 against the torso 230 (e.g., chest).

The compressibility of the arm positioning device 100, especially the middle portion 130, can be selected to enable the outer surface 120 of the device 100 to conform to the patient's torso 230 or other support surface to help distribute the load of the arm 210. For example, when the arm of a patient is positioned across the chest, the middle portion 130 may compress somewhat under the weight of the arm to conform to the surface of the chest, including bony protuberances of the ribs and/or sternum as well as breasts of the patient (In the case of a woman), reducing the load of the arm 210 or other forces on the arm positioning device 100 and application or forces to the pressure points of the patient's anatomy where sores can form. In this manner, the arm positioning device 100 reduces the formation of sores or excessive rubbing against the patient's anatomy, thus providing protection to the patient's body in addition to the patient's arm 210. In another example, when the patient 200 is positioned in a supine position, the arm 210 of the patient 200 may be positioned on an arm board (not shown) extending along or away from the torso 230 of the patient 200, with the device 100 acting cushion the arm 210 against the arm board, which can be rigid and otherwise uncomfortable to the arm 210.

FIG. 10 illustrates how the arm positioning device 100 can be deployed when the patient 200 is in the fowler or semi-fowler position (i.e., where the patient 200 is positioned at an upright or inclined angle). In this position, the middle portion 130 of the arm positioning device 100 may, similar to above, be positioned between the arm 210 and the torso 230 of the patient 200. The thickness T1 of the middle portion 130 may be configured to comfortably and effectively space the arm 210 apart from the lateral side of the torso 230. In this manner, the arm positioning device 100 device 100 can prevent the arm 210 from rubbing against the patient's torso 230, including bony protuberances where sores can form, such as the patient's ribs. The above arrangement may also help to prevent tension buildup in the patient's shoulder 220 during the medical procedure. The arm positioning device 100 device 100 may also be useful in positioning an arm 210 of the patient 200 when the patient 200 is in one of a variety of other positions, such as the prone position, lateral position, Sim's position, or jackknife position.

### Arm Positioning Device With Securement Mechanism

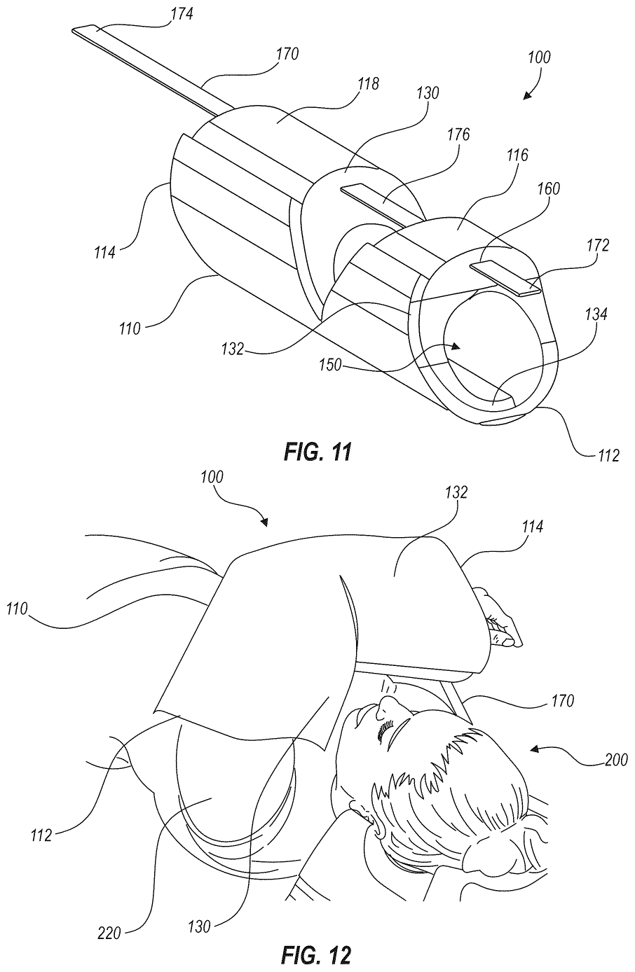

FIGS. 11 and 12 illustrate an arm positioning device 100 configured to be secured to a patient's body and/or support surface. In this embodiment, the arm positioning device 100 includes a securement mechanism configured to attach the device 100 to the patient's body and/or support surface. The securement mechanism may be used to position and prevent movement of the arm positioning device 100 with enclosed arm 210 during a medical procedure, including to prevent the arm 210 of the patient 200 from interfering with the surgical surface and/or maintain the position of the arm 210 during a medical procedure performed on the arm 210. The securement mechanism may be configured to secure the arm positioning device 100 (and thus the enclosed arm 210 of the patient 200) adjacent to the body of the patient 200. For example, the securement mechanism may be configured to secure the device to the torso 230 of the patient 200. Additionally, or alternatively, the securement mechanism may be configured to secure the device 100 to a support surface, such as an operating table, chair, arm board, or other structure.

The securement mechanism may comprise an anchoring strap 170 configured to attach to the body 110 of the arm positioning device 100. The anchoring strap 170 may comprise a strap, cable, wire, band, cord, rope, chain, belt, harness, or other elongate member configured to tether the body 110 to the patient and/or support surface. The anchoring strap 170 may be placed in tension to secure the body 110 and the patient's arm 210 in a desired position relative to the patient and/or support surface. The anchoring strap 170 may be placed in tension to exert a tensioning force on the arm positioning device 100 to thereby limit movement of the arm 210 of the patient 200 relative to the patient and/or support surface.

The securement mechanism may comprise a receiving component formed by or attached to the body 110 of the arm positioning device 100 that may receive or be attached to the anchoring strap 170. As illustrated, the body 110 of the device 100 may define one or more slots 160 configured to receive the anchoring strap 170. The middle portion 130 may define the one or more slots 160, particularly in embodiments wherein the middle portion 130 has a thickness greater than that of the first and second wrap portions 132, 134. In this way, the thickness of the first and second wrap portions 132, 134 may be maintained relatively thin while enabling the anchoring strap 170 to securely integrate with the device 100. The one or more slots 160 may be formed in the middle portion 130 and may extend along the entire length of the middle portion 130. The one or more slots 160 may have dimensions similar to that of a cross-section of the anchoring strap 170 so as to provide a firm and tight fit with the anchoring strap 170, while still allowing some relative longitudinal movement top facilitate adjustments. For example, the one or more slots 160 may have a width of about 0.5 to 1.5 inch, or about 0.75 to about 1.25 inch, or about 1 inch, to approximate the width of an anchoring strap 170 or to accommodate multiple anchoring straps 170 having a corresponding width (e.g., about 0.5 to 1.5 inch, or about 0.75 to about 1.25 inch, or about 1 inch).

The anchoring strap 170 may comprise a proximal end 172 configured to attach or otherwise secure to the body 110 of the arm positioning device 100 (e.g., at proximal end 112 of the body 110) and a distal end 174 that extends beyond the distal end 114 of the body 110 and is configured to attach or otherwise secure to a patient and/or support surface. In some embodiments, the proximal end 172 of the anchoring strap 170 may be sized to prevent movement through the slots 160. For example, the proximal end 172 may have a thickness that is greater than the height of the one or more slots 160, such that the proximal end 172 is prevented from passing through the one or more slots 160. In other embodiments, the proximal end 172 of the anchoring strap 170 may, after being threaded through a slot of the one or more slots 160, be re-threaded back into an end of the slot so as to create a wedge and secure the proximal end 172 of the anchoring strap 170 to the body 110 of the device 100. Additionally, or alternatively, the proximal end 172 of the anchoring strap 170 may be tied to the body 110, adhered to the body 110, or may comprise a fastening mechanism, such as a hook and loop fastener, a button and hole fastening mechanism, a snap button, a buckle, or other fastening mechanism configured to connect with a fastening mechanism of the body 110 and thereby secure the anchoring strap 170 to the body 110.

In some embodiments, the body 110 may additionally or alternatively form loops (not shown) extending from or attached to an outer surface 120 of the body 110 and configured to receive the anchoring strap 170. Such loops may be formed on the proximal and/or distal portions 116, 118 of the body 110 and may enable the medical practitioner to effectively tie down or otherwise secure the device 100 (and thereby the arm 210) to a patient and/or support surface.

FIG. 12 illustrates the arm positioning device 100, including the body 110 secured to a support surface by means of the anchoring strap 170. The proximal end 172 of the anchoring strap 170 may thus be configured to attach or otherwise secure to the body 110 of the arm positioning device 100. The distal end 174 of the anchoring strap 170 may extend beyond the arm positioning device 100 and be configured to attach to the patient and/or a support surface. The anchoring strap 170 may be tensioned and oriented to pull the arm 210 distally or otherwise manipulated to help maintain a desired arm position.

The foregoing illustrates how the arm positioning device 100 and the arm 210 of the patient 200 can be secured in a desired position relative to the patient's body and/or a support surface. For example, the arm 210 may be secured across the torso 230 of the patient 200, the arm 210 being pulled in tension by the anchoring strap 170 and the body 110 of the arm positioning device 100 to at least partially fix the arm 210 in the particular position. In this manner, the anchoring strap 170 and the body 110 may prevent horizontal abduction of the shoulder 220 (i.e., to prevent the shoulder from falling posteriorly). Maintaining the arm 210 in this position may facilitate a medical practitioner to perform a medical procedure on, for example, the exposed shoulder 220 or lateral side of the torso 230 without interference from the arm 210.

Positioning of the device body 110 may cause the cutout angle A1 of the first cutout 140 to close toward full flexion of the body 110, such that the cutout angle A1 between the first and second walls 142, 144 of the first cutout 140 is decreased or moved to zero. However, in some embodiments, the arm 210 may be placed in tension without completely closing the first cutout 140. This may be achieved in some instances through use of an angle adjustment mechanism comprising a clamp or other fixture configured to selectively attach to a middle section 176 of the anchoring strap 170 disposed within the first cutout 140. Specifically, the angle adjustment mechanism may be attached to a location along the middle section 176 of the anchoring strap 170 according to the desired cutout angle A1 of the first cutout 140. As the anchoring strap 170 is placed in tension during securement to the securement surface, the angle adjustment mechanism is pulled up against the walls 142, 144 of the first cutout 140 to limit closure of the cutout 140.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention. Furthermore, it should be understood that for any given element or component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

The embodiments disclosed herein should be understood as comprising/including disclosed components, and may therefore include additional components not specifically described. Optionally, the embodiments disclosed herein are free of components that are not specifically described. That is, non-disclosed components may optionally be omitted or from the disclosed embodiments. For example, additional straps, closure mechanisms, fixation hardware, cutouts, and/or device body shapes that are not specifically disclosed herein may optionally be omitted.

Embodiments described herein may include properties and/or features described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. An arm positioning device configured to position and/or protect an arm of a patient during a medical procedure, the arm positioning device comprising:
an elongate body having a longitudinal axis and being configured to at least partially surround the arm of the patient;
wherein the arm positioning device is configured to be selectively arranged between a wrapped configuration and an unwrapped configuration;
wherein when the arm positioning device is arranged in the unwrapped configuration the arm positioning device is configured to receive the arm of the patient; and
wherein when the arm positioning device is arranged in the wrapped configuration the elongate body defines a lumen configured to receive and hold therein the arm of the patient, and the elongate body is configured to facilitate bending of the arm and elongate body in a bending direction transverse to the longitudinal axis.

2. The arm positioning device of claim 1, wherein the elongate body comprises a middle portion, a first wrap portion extending from a first side of the middle portion, and second wrap portion extending from a second side of the middle portion.

3. The arm positioning device of claim 2, wherein the first and/or second wrap portions comprise a connection mechanism for selectively connecting the first and second wrap portions together to arrange the device in the wrapped configuration and disconnecting the first and second wrap portions to arrange the device in the unwrapped configuration.

4. The arm positioning device of claim 2, wherein the middle portion has a thickness greater than a thickness of each of the first and second wrap portions.

5. The arm positioning device of claim 4, wherein the elongate body tapers in thickness from the middle portion to the first and second wrap portions.

6. The arm positioning device of claim 2, wherein the middle portion includes a slot extending along the longitudinal axis of the elongate body.

7. The arm positioning device of claim 6, further comprising an anchoring strap configured to be received by the slot and configured to secure the elongate body to the patient's body and/or a support surface.

8. The arm positioning device of claim 1, wherein the elongate body comprises a proximal portion configured in length to approximate the length of an upper portion of the patient's arm and a distal portion configured in length to approximate the length of a forearm of the patient's arm.

9. The arm positioning device of claim 8, wherein the elongate body includes a first cutout configured to facilitate bending the distal portion of the elongate body in a bending direction relative to the proximal portion of the elongate body.

10. The arm positioning device of claim 9, wherein the arm positioning device is configured to align the first cutout with a joint along the arm of the patient when in the wrapped configuration.

11. The arm positioning device of claim 9, wherein the first cutout extends into the middle portion of the elongate body.

12. The arm positioning device of claim 11, wherein the first wrap portion includes a second cutout extending from an end of the first wrap and aligned with the first cutout.

13. The arm positioning device of claim 9, wherein the first cutout comprises a V-shaped cutout.

14. The arm positioning device of claim 1, wherein the lumen is defined by an inner surface of the elongate body having a generally cylindrical shape when the arm positioning device is arranged in the wrapped configuration.

15. The arm positioning device of claim 1, wherein the elongate body comprises a polymer foam material.

16. An arm positioning device configured to position and/or protect an arm of a patient during a medical procedure, the arm positioning device comprising:
an elongate body comprising a polymer foam material and including a proximal portion, a distal portion, and a generally cylindrical inner surface defining a lumen configured to receive the arm of a patient;
wherein the elongate body further defines a cutout configured to facilitate bending of the distal portion of the elongate body in a direction relative to the proximal portion of the elongate body,
wherein the elongate body comprises a middle portion having a thickness greater than that of other portions of the elongate body, wherein the cutout extends into a middle portion of the elongate body, wherein the middle portion defines a slot extending along the elongate body,
the arm positioning device further comprising an anchoring strap configured to be received by the slot and configured to secure the elongate body to the patient and/or a support surface.

17. The arm positioning device of claim 16, wherein the proximal portion is configured in length to approximate the length of an upper portion of the patient's arm and the distal portion is configured in length to approximate the length of a forearm of the patient's arm, wherein the arm positioning device is configured to align the cutout with a joint of the arm of the patient.

18. The arm positioning device of claims 16, wherein the cutout comprises a V-shaped cutout.

19. An arm positioning device configured to protect and/or position an arm of a patient during a medical procedure, the arm positioning device comprising:
an elongate body having a longitudinal axis and configured to wrap around and at least partially surround the arm of the patient, the elongate body comprising a middle portion, a first wrap portion extending from a first side of the middle portion, and second wrap portion extending from a second side of the middle portion, the middle portion including one or more slots therein;
an anchoring strap configured to be received by the one or more slots and to secure the elongate body to the patient's body and/or a support surface;
wherein the elongate body defines a cutout configured to facilitate bending of the elongate body in a direction transverse to the longitudinal axis;
wherein the arm positioning device is configured to be selectively arranged between a wrapped configuration and an unwrapped configuration;
wherein the arm positioning device is configured to receive the arm of the patient when the arm positioning device is arranged in the unwrapped configuration; and
wherein when the arm positioning device is in the wrapped configuration the elongate body defines a lumen configured to receive and secure to the arm of the patient.

20. A method of using an arm positioning device, the method comprising:
providing the arm positioning device, the arm positioning device including:
an elongate body having a longitudinal axis and configured to surround the arm of a patient, the elongate body comprising a middle portion, a first wrap extending from a first side of the middle portion, and second wrap extending from a second side of the middle portion,
wherein the arm positioning device is configured to be selectively arranged between a wrapped configuration and an unwrapped configuration,
wherein when the arm positioning device is arranged in the unwrapped configuration the arm positioning device is configured to receive a patient arm, and
wherein when the arm positioning device is arranged in the wrapped configuration the elongate body defines a lumen configured to receive and hold therein the arm of the patient, and the elongate body is configured to facilitate bending of the arm and elongate body in a bending direction transverse to the longitudinal axis;
positioning the arm positioning device on a support surface in the unwrapped configuration;
positioning the patient arm in the lumen of the arm positioning device;
arranging the arm positioning device in the wrapped configuration to secure the arm positioning device to the patient arm.
